(19) United States
(12) Patent Application Publication
(10) Pub. No.: US 2011/0108419 A1
(43) Pub. Date: May 12, 2011

(54) HEATED BISTABLE SENSOR HAVING SIMPLIFIED ELECTRICAL CONTACTING

(76) Inventors: Lothar Diehl, Gerlingen (DE); Thomas Seiler, Stuttgart (DE)

(21) Appl. No.: 12/736,516

(22) PCT Filed: Mar. 6, 2009
(86) PCT No.: PCT/EP2009/052666

§ 371 Date: Jan. 18, 2011

(30) Foreign Application Priority Data
Apr. 17, 2008 (DE) 10 2008 001 223.8

(51) Int. Cl. G01N 27/30

(52) U.S. Cl. 204/412; 204/424; 204/427; 204/428

(57) ABSTRACT

A sensor element for determining a physical property of a gas in a measuring gas chamber includes at least two electrodes, at least one solid-state electrolyte connecting the electrodes, and at least one heating element having at least two heating contacts. A first heating contact and a first electrode are contacted via a common connecting line, and a second heating contact and a second electrode are connected to a common ground line.

### BACKGROUND OF THE INVENTION

1. Field of the Invention

The present invention relates to known sensor elements which are based on electrolytic properties of specific solids, i.e., the ability of these solids to conduct specific ions.

2. Description of Related Art

Sensor elements of this type are used, in particular, in motor vehicles to measure air/fuel/gas mixture compositions, in which case these sensor elements are also known by the designation “lambda sensor” and play a key role in reducing harmful substances in exhaust gases in both spark ignition engines and in diesel technology.

In combustion technology, the so-called “lambda” (λ) excess air factor generally describes the ratio between an air mass actually provided and an air mass theoretically required for combustion (i.e., stoichiometric air mass). The excess air factor is measured using one or more sensor elements at least at one or more points in the exhaust gas tract of an internal combustion engine. Accordingly, “rich” gas mixtures (i.e., gas mixtures having excess fuel) have an excess air factor of λ<1, while “lean” gas mixtures (i.e., gas mixtures having low fuel concentration) have an excess air factor of λ>1. In addition to automotive technology, these and similar sensor elements are also used in other areas of technology (in particular in combustion technology), for example in aeronautics or in regulating burners, e.g., in heating systems or power plants.

Sensor elements of this type are currently known in numerous different specific embodiments. One specific embodiment is the so-called “bistable sensor,” whose measuring principle is based on measuring an electrochemical difference in potential between a reference electrode exposed to a reference gas and a measuring electrode exposed to the gas mixture to be measured. The reference electrode and the measuring electrode are connected to each other via the solid-state electrolyte, doped zirconium dioxide (such as yttrium-stabilized ZrO₂) or similar ceramics ordinarily being used as the solid-state electrolyte, due to their oxygen ion-conductive properties. The potential difference between the electrodes theoretically has a characteristic discontinuity, particularly in the transition between a rich gas mixture and a lean gas mixture, and this discontinuity may be used to actively regulate the gas mixture composition around discontinuity point λ=1. Different exemplary embodiments of bistable sensors of this type, which are also referred to as “Nernst cells,” are described, for example, in the publication by Robert Bosch GmbH: Sensoren im Kraftfahrzeug (Sensors in Motor Vehicles)” 1^{st} edition, 2001, pp. 112-115.

As an alternative or in addition to bistable sensors, so-called “pump cells” are also used in which an electrical “pump voltage” is applied to two electrodes which are connected via the solid-state electrolyte, the “pump current” being measured by the pump cell. In contrast to the principle of bistable sensors, both electrodes in pump cells are ordinarily in contact with the gas mixture to be measured. One of the two electrodes is directly exposed to the gas mixture to be measured (usually via a permeable protective layer). However, the second of the two electrodes is designed in such a way that the gas mixture is unable to directly reach this electrode, but must first penetrate a so-called “diffusion barrier” to reach a cavity adjacent to this second electrode. A porous ceramic structure having selectively settable pore radii is usually used as the diffusion barrier. If lean exhaust gas enters the cavity through this diffusion barrier, the pump voltage is used to electrochemically reduce oxygen molecules at the second, negative electrode into oxygen ions and to transport them through the solid-state electrolyte to the first positive electrode, where they are released as free oxygen. The sensor elements are usually operated in so-called limiting current mode, i.e., in a mode in which the pump voltage is selected in such a way that the oxygen passing through the diffusion barrier is fully pumped to the counter-electrode. In this mode, the pump current is approximately proportional to the partial pressure of the oxygen in the exhaust gas mixture, so that sensor elements of this type are frequently also referred to as proportional sensors. In contrast to bistable sensors, proportional sensors of this type may be used for the lambda excess air factor over a comparatively broad range in the form of so-called broadband sensors.

In many sensor elements, the sensor principles described above are also combined, so that the sensor elements include one or more sensors (“cells”) operating according to the bistable sensor principle and also include one or more proportional sensors. For example, the principle described above of a “single-cell sensor” operating according to the pump cell principle may be expanded to a “dual-cell sensor” by adding a bistable cell (Nernst cell). A structure of this type is described, for example, in published European patent document EP 0 678 740 B1. In this case, a Nernst cell is used to measure the oxygen partial pressure in the above-described cavity adjacent to the second electrode, and the pump voltage is usually supplied by a regulating system so that the condition λ=1 always prevails in the cavity. Other regulating systems are also conceivable. Further examples of sensor elements of this type are described in the publication by Robert Bosch GmbH: “Sensoren im Kraftfahrzeug” (Sensors in Motor Vehicles), 2001, pp. 116-117.

In the case of bistable sensors in particular, but also in other types of sensor elements in which the potential of an electrode on the exhaust gas side is measured relative to an oxygen-flushed reference electrode, two connecting lines are ordinarily required for the sensor element for this measurement alone. In addition, two further connecting lines are ordinarily used for heating, so that a total of four cables is frequently required. Operating the sensor elements without a heating element is not possible in many cases, since unheated sensors are too cold in some operating states to supply useable signals. However, the number of connecting lines or cables of the sensor element is a key factor in the sensor element price. Efforts have therefore been made to reduce the number of connecting contacts. For example, published German patent application document DE 10 2005 003 813 A1 describes a sensor element in which the Nernst voltage is measured relative to a vehicle ground when the reference electrode is connected to ground. The bistable sensor may thus be operated in such a way that a heater supply is conducted via the same cable as one of the two terminals for the Nernst cell, the signal being evaluated in cycles. This enables a heated bistable sensor to be operated using three cables or terminals. However, even in the sensor element described in published German patent application document DE 10 2005 003 813 A1, there remains a need for additional savings to further reduce the costs of the sensor elements.

### BRIEF SUMMARY OF THE INVENTION

A basic idea of the present invention is to read out the Nernst voltage and to heat the sensor via the same, preferably a single, connecting cable and to carry out the heating or readout relative to a ground, in particular to a vehicle ground. According to the present invention, a sensor element as well as a sensor system including the sensor element are thus described which make it possible to greatly reduce the number of contacts by which the sensor element must be contacted, in particular the number of cables and/or supply lines, to as few as a single cable.

The sensor element is used to determine at least one physical property of a gas in a measuring gas chamber. In particular, the sensor element may be designed to determine a concentration and/or a partial pressure of a gas component in a gas in the measuring gas chamber, in particular an oxygen concentration or an oxygen partial pressure. The sensor element may be preferably used in particular in the exhaust gas of an internal combustion engine. However, other designs, gas components to be detected and applications are conceivable.

The sensor element has at least one first electrode, at least one second electrode, and at least one solid-state electrolyte connecting the first electrode and the second electrode. The solid-state electrolyte may be, for example, an oxygen ion-conductive solid-state electrolyte, for example yttrium-stabilized zirconium dioxide (YSZ). However, other solid-state electrolyte materials may also be used. The electrodes may include, for example, cermet electrodes, for example platinum cermet electrodes. The at least two electrodes and the solid-state electrolyte may form a Nernst cell.

The sensor element also has at least one heating element. This heating element may include, for example, a meander path of heating resistors. The heating element may be designed, in particular, to heat the sensor element to an optimum operating temperature, for example a temperature between 500° C. and 800° C. The heating element has at least two heating contacts. At least one first heating contact of these heating contacts and the first electrode are contactable via a common connecting line. This common connecting line is preferably integrated into a ceramic layer structure of the sensor element, so that the connecting line may be contacted by a single external terminal. At least one second heating contact of the heating contacts and the second electrode are connected to a common ground line. For example, this common ground line may also be fully integrated into the ceramic layer structure and be contacted, for example, by a housing of the sensor element, for example a metal housing, so that external contacting of this ground line via a contact or a cable is not necessary. However, external contacting of this type is also possible. In contrast to the related art, the heating element, in particular one or more heating meanders of the heating element, is thus preferably parallel-connected to the Nernst cell. This makes it possible to eliminate supply lines, so that the sensor element may ultimately be operated using only one supply line.

The first electrode is preferably connected to the measuring gas chamber, for example directly or via a gas-permeable protective layer, for example porous aluminum oxide. The second electrode is preferably connected to a reference gas chamber which is isolated from the measuring gas chamber. In this manner, the first electrode and the second electrode, together with the solid-state electrolyte, may form a Nernst cell in which the potential of the first electrode is compared with the potential of the second electrode in the reference gas chamber. The reference gas chamber may include, for example, a reference gas channel connected to a working environment. For example, the working environment may include an engine compartment in which air is present under normal conditions. However, other designs of the reference gas chamber are also possible. For example, a closed reference gas chamber may be used, i.e., a reference gas chamber to which no gas or only an inconsiderable amount of gas from the measuring gas chamber and/or the working environment is applied. In this case, for example, a reference atmosphere within the closed reference gas chamber may be maintained or provided by operating this reference gas chamber as a “pumped reference,” as is known, for example, from the related art described above. The sensor element may include, for example, at least one further pump electrode for this purpose. This further pump electrode, which may be either entirely or partially identical to the first electrode, may be situated, for example, in a reference gas channel which is spatially isolated from the reference gas chamber to provide a specific atmosphere (for example, λ=1) in the reference gas chamber, together with the electrode in the reference gas chamber, for example controlled by a corresponding regulating system.

It is particularly preferable if at least one protective resistor, for example an ohmic protective resistor, is provided between the first electrode and the common connecting line. This protective resistor may be fully integrated into the ceramic sensor element, for example into a layer structure of this sensor element. As an alternative or in addition, however, a design of the protective resistor outside the layer structure is, in principle, also conceivable.

If the at least one protective resistor is used, in particular if the protective resistor is at least partially integrated into the layer structure, the heating element is parallel-connected to the Nernst cell and the protective resistor. The protective resistor is used to avoid damage to the Nernst cell in this parallel circuit, in particular if a cyclical mode of sensor element operation is used, as described in greater detail below. The Nernst cell, which includes the first electrode, the solid-state electrolyte, and the second electrode, preferably has a Nernst cell resistance. In this case, the protective resistor is preferably selected in such a way that its absolute value is 2 to 10 times, preferably approximately 6 times, the absolute value of the Nernst cell resistance, i.e., at typical operating temperatures of the sensor element, for example. This ensures that the overwhelming proportion of the voltage which drops across the heating element and which also drops across the parallel branch including the Nernst cell and the protective resistor, due to the parallel circuit described, is present at the protective resistor, thereby avoiding damage to the Nernst cell.

However, the additional protective resistor may advantageously be omitted altogether, in particular if the ohmic resistance of the Nernst cell itself is designed to be sufficiently high. This may be achieved, for example, via a sufficient thickness of the solid-state electrolyte, for example the ZrO₂ material, and/or via its composition. The resistance selected should be at least high enough that a sufficiently large proportion of the heating voltage drops across the solid-state electrolyte, for example the ZrO₂ ceramic, in particular after reaching the operating temperature, the voltage drop at the interface between the solid-state electrolyte and the electrode or electrodes being small enough to prevent damage.

A sensor system for determining at least one physical property of a gas in a measuring gas chamber is also proposed, which includes at least one sensor element according to one or more of the exemplary embodiments described above. The sensor system further includes at least one controller, which may be integrated, for example, either partially or entirely into an engine control unit of a motor vehicle. However, a separate controller is also possible. The controller may be configured to carry out the method described below for operating the sensor element, so that an operating method of this type for operating the sensor element is also proposed according to the present invention, in addition to the described controller and the sensor system. The controller function may be carried out, for example, entirely or partially by a data processing unit, and it may include corresponding program steps which are implemented, for example, by a suitable computer program.

The controller is configured to connect the connecting line to either an electrical energy source or a measuring device. For example, one or more switches may be provided for this selective connection, so that an either-or connection, in particular, may be established. The electrical energy source may include, for example, a voltage source and/or a current source. For example, the controller may be configured to connect the connecting line to an electrical positive pole of the electrical energy source. The measuring device may include, in particular, an electrical measuring device, in particular a voltage measuring device and/or a current measuring device.

While the sensor system described above, having the first and second electrodes, the solid-state electrolyte, the connecting line and the ground line, is preferably designed as a monolithic sensor element, i.e., as a single ceramic layer structure, the controller is preferably designed separately from this layer structure. For this purpose, the controller may be connected to the sensor element, for example, via one or more connecting lines or cables. As described above, only one cable is preferably used to connect the controller to the connecting line, while the ground line is connected to a ground of the sensor element. This ground, which may include, for example, a sensor housing, may be connected, for example, to an engine block or the ground of a motor vehicle.

It is particularly preferable if the controller is configured in such a way that the connecting line is connected to the electrical energy source during at least one heating phase and to the measuring device during at least one measuring phase. The controller may be configured, in particular, to infer the physical property of the gas, in particular an oxygen concentration or an oxygen partial pressure, from at least one signal of the measuring device. This evaluation process may take place in absolute terms by correlating the absolute signal of the measuring device, for example analytically, empirically or semi-empirically, with the physical property, for example using corresponding evaluation functions, tables, correlation curves and the like. As an alternative or in addition, however, a two-point regulation method may be used, for example, in which the evaluation step only involves determining whether, for example, a gas mixture is in a rich state or in a lean state. In this case, the evaluation is a digital evaluation, which only supplies an item of rich/lean information instead of an absolute measured value.

It is preferable in particular to operate the sensor element in cycles. In this case, the Nernst voltage is preferably output during a period between two heating cycles. Accordingly, it is possible to alternately switch back and forth between heating phases and measuring phases. For example, the heating phases may be designed to be longer than the measuring phases. Variable time lengths for the phases are also conceivable, for example within the framework of a pulse width modulation.

Since a non-negligible voltage ordinarily drops across the Nernst cell when the heating element is parallel-connected to the Nernst cell, despite the protective resistor, a variation in the gas mixture composition in the reference gas chamber may occur under some circumstances during the heating phase, due to pumping effects through the Nernst cell. If a reference gas channel is used, for example, the subsequent inflow or outflow from the area around the second electrode may be limited, so that the pumping action empties the reference gas channel or the oxygen partial pressure in the reference gas channel decreases in the area of the second electrode. This effect may be mitigated by operating the heating element with alternating polarity. For this purpose, the controller may be configured, for example, to operate the heating element with alternating electrical polarity in consecutive heating phases.

In this manner, a sensor element and a sensor system, which have an extremely simple structure and which nevertheless simultaneously provide a reliable and controllable reference for measuring the Nernst potential, may be manufactured by implementing the idea according to the present invention.

### BRIEF DESCRIPTION OF THE DRAWING

FIG. 1 shows an exemplary embodiment of a sensor system according to the present invention, having a single supply line and a reference air channel.

### DETAILED DESCRIPTION OF THE INVENTION

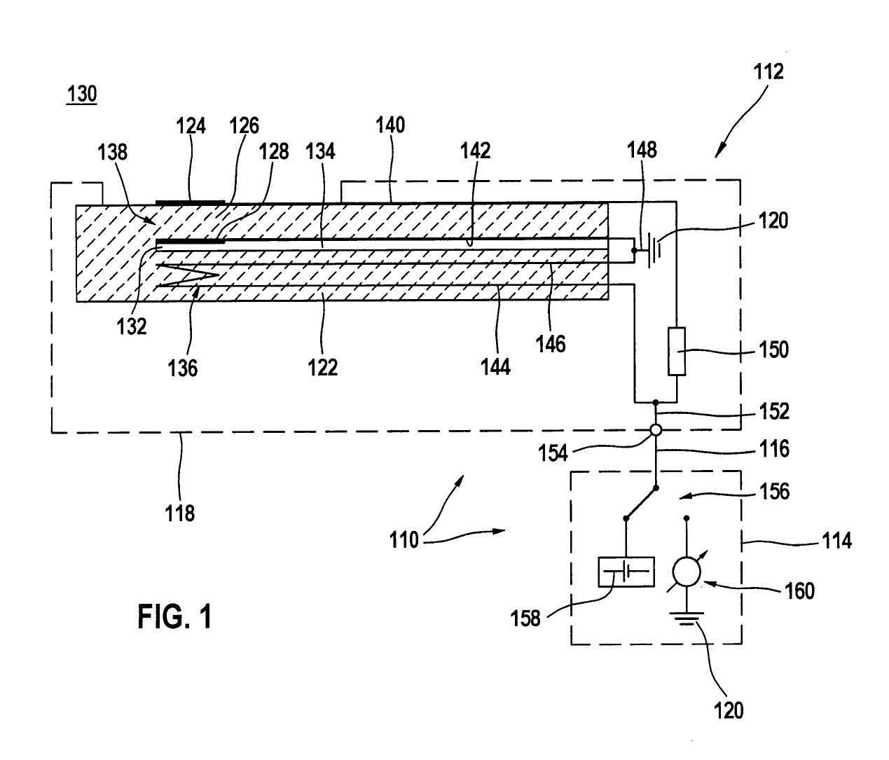

FIG. 1 shows a schematic diagram of an exemplary embodiment of a sensor system 110 according to the present invention. Sensor system 110 includes a sensor element 112 and a controller 114, which are connected to each other by a single supply line 116. Sensor element 112 includes a housing 118, which is indicated symbolically in FIG. 1 and which is connectable, for example, to a ground 120 of a motor vehicle. In the housing, the actual active sensor element is integrated as ceramic layer structure 122. For possible housing designs 118, in particular structural designs and other details, reference may be made to the publication by Robert Bosch GmbH: “Sensoren im Kraftfahrzeug” (Sensors in Motor Vehicles), 1^{st} edition, 2001, pages 112 through 115.

Sensor element 112, or ceramic layer structure 122, includes a first electrode 124, a solid-state electrolyte 126, and a second electrode 128. While first electrode 124 is connected to a measuring gas chamber 130, for example an exhaust gas tract of an internal combustion engine, in which an oxygen concentration or an oxygen partial pressure is to be ascertained, second electrode 128 is situated in a reference gas chamber 132. In the exemplary embodiment illustrated in FIG. 1, this reference gas chamber 132 is part of a reference air channel 134, via which reference gas chamber 132 is connected, for example, to an engine compartment which is isolated from measuring gas chamber 130. Reference air channel 134 may be designed, for example, as an open channel or as a reference air channel which is filled with a gas-permeable, porous medium (for example, an open-pore aluminum oxide). The connection between reference air channel 134 and the working environment, in particular the engine compartment, is not illustrated in FIG. 1.

In the exemplary embodiment in FIG. 1, sensor element 112 further includes a heating element 136. This heating element 136 is used to regulate sensor element 112 to an optimum operating temperature, for example to set an oxygen ion conductivity of solid-state electrolyte 126 and to ensure an adequate resistance against harmful substances from the exhaust gas.

The two electrodes 124 and 128 and solid-state electrolyte 126 connecting these electrodes together form a Nernst cell 138. While first electrode 124 is connected to measuring gas chamber 130 directly or via a gas-permeable protective layer (for example an open-pore aluminum oxide layer, which is not illustrated in FIG. 1), a defined gas composition is applied to second electrode 128 via reference air channel 134. Nernst cell 138 thus has a first Nernst cell supply line 140, which is situated on the upper side of ceramic layer structure 122 and which contacts first electrode 124, for example in the form of a conductor track, and a second Nernst cell supply line 142, which is situated, for example, in reference air channel 134 and which contacts second electrode 128.

Accordingly, heating element 136, which is designed, for example, as a heating meander or includes, for example, at least one heating meander, has a first heating contact 144 and a second heating contact 146. Heating contacts 144, 146 and Nernst cell supply lines 140, 142 may be implemented, for example, as printed conductive tracks in layer structure 122 and they may include additional insulation layers, which are not illustrated in FIG. 1.

According to the present invention, in sensor element 112 in FIG. 1, the second Nernst cell supply line, which contacts second electrode 128 acting as a reference electrode, and second heating contact 146 are connected to a common ground line 148. Lines 142 and 146 may be combined in this way within layer structure 122, or they may be combined outside this layer structure, but within housing 118. Combining the lines within the layer structure is possible, for example, by using appropriate through-contacts. A means of combining the lines to form a common ground line 148 outside ceramic layer structure 122 is indicated symbolically in FIG. 1. Ground line 148 may be connected, for example, to ground 120, which, in turn, may be connected, for example, to housing 118.

A protective resistor 150 is integrated into first Nernst cell supply line 140. This protective resistor 150 may be, for example, part of ceramic layer structure 122 or, alternatively or in addition and as illustrated in FIG. 1, it may also be implemented outside ceramic layer structure 122. Ohmic resistors may be produced, for example, by appropriate printed layers, for example by ceramic printed layers or similar materials. It is also conceivable to distribute protective resistor 150 to multiple partial resistors, which may be connected in series, for example. Instead of protective resistor 150, it is also possible as an alternative to select a sufficiently high resistance of Nernst cell 138, for example by selecting a suitable geometry and/or by selecting a suitable material composition and/or by a suitable operating temperature, as described above.

First Nernst cell supply line 140 and first heating contact 144 are connected to a common connecting line 152. Lines 140, 144 may again be connected in this way to common connecting line 152, for example within ceramic layer structure 122, for example by using corresponding through-contacts. In this case, protective resistor 150 is preferably part of ceramic layer structure 122. Alternatively, the connection to common connecting line 152 may also take place outside ceramic layer 122, as indicated in FIG. 1.

In the exemplary embodiment illustrated in FIG. 1, sensor element 112 thus has only a single connecting contact, which is designated symbolically by reference numeral 154 and which is connected to connecting line 152. Connecting contact 154, in turn, may be connected to supply line 116, which connects sensor element 112 to controller 114.

A switch 156, which may be used to connect common connecting line 152 to either an electrical energy source 158 or a measuring device 160, is provided within the controller. Switch 156 may be, for example, a switch which is controlled by an electronic control device, for example a microcontroller. Electrical energy source 158 may include, for example, a voltage source, for example a voltage source having a constant voltage of approximately 11 V, connecting line 152 being connectable, for example, to a positive pole of this voltage source via switch 156.

As shown in FIG. 1, measuring device 160 may include, for example, a voltage measuring device, which is indicated symbolically in FIG. 1. For example, the voltage may be measured via a measuring shunt (not illustrated in FIG. 1). Measuring device 160 may be connected, for example, to a ground 120 on its side diametrically opposite to switch 156.

In common sensor elements according to the related art, the Nernst voltage is tapped at Nernst cell 138, usually between first electrode 124 acting as the Nernst electrode and second electrode 128 acting as the reference electrode, and a setpoint value for λ=1 is set, for example to 450 mV. The reference electrode lies on zirconium oxide and is located in reference air channel 134 or is operated as a pumped reference. In common sensor elements, heating element 136 has two separate terminals. On the whole, it must be possible to contact the sensor element using four contacts or terminals.

In contrast, sensor element 112 according to the present invention and shown in FIG. 1 is designed in such a way that it may be contacted using exclusively single supply line 116. The heater circuit of heating element 136 has only a single connecting cable, and the current flows from the positive pole of energy source 158 to vehicle ground 120 via heating element 136. Nernst cell 138 and protective resistor 150, which is series-connected thereto, are parallel-connected to the heating meander of heating element 136.

The heating meander of heating element 136 is preferably designed to be as highly resistive as possible, for example to have a heating resistance of 30 ohms. At a voltage of, for example, 10.7 V, a heating capacity of approximately 3.8 W may be fed into heating element 136, a potentially large proportion of which should drop across the meander, i.e., across the actual heating resistor of heating element 136, due to the low-resistance design of the supply line (i.e., lines 144, 146, 148 and 116).

Nernst cell 138 preferably has a Nernst cell resistance and heating element 136 a heater resistance. The heater resistance and the Nernst cell resistance are selected in such a way that the heater resistance is at least approximately one fifth of the Nernst cell resistance (i.e., for example having a deviation of no more than 20%), plus the resistance of the optional protective resistor 150, at the operating temperature.

Since sensor element 112 has only single connecting contact 154, and Nernst cell 138 and heating element 138 are parallel-connected, sensor system 110 should be activated in cycles by controller 114. For this purpose, switch 156 may be switched back and forth in cycles, for example controlled by software, so that, for example, switch 156 is in the position illustrated in FIG. 1 during heating phases, while switch 156 is switched during measuring phases in such a way that supply line 116 is connected to measuring device 160. The heating and measuring phases may be designed to be of equal length or of different lengths. A variable design is also possible, for example achieved by inserting one or more measuring phases between one or more longer heating phases only as needed.

To prevent heating element 136 from cooling, in particular during the measuring phases, a high pulse duty factor, i.e., a high ratio between heating phases and measuring phases, is preferably selected in the case of cyclical switching. For example, pulse duty factors between 20% and 50% may be selected. Housing 118 may also be designed as a protective tube, which may have a closed design.

If protective resistor 150 is used, Nernst cell 138 should have a minimal d.c. resistance, for example no more than 20 ohms. Protective resistor 150 of Nernst cell 138 should be approximately six times the Nernst cell resistance of Nernst cell 138, i.e., for example 120 ohms. During the heating phases, i.e., in the cycle in which heating element 136 is being acted upon, there is an approximately 11 V voltage drop across the heating meander of heating element 136 in the above-described exemplary embodiment. Due to the parallel circuit according to the present invention, the same voltage drop occurs across Nernst cell 138 and protective resistor 150. Using the aforementioned resistance ratios, an approximately 1.5 V voltage drop occurs across Nernst cell 138 at the operating temperature, while the remaining voltage drop occurs at protective resistor 150. At this voltage, no damage yet occurs to Nernst cell 138, in particular to the zirconium oxide of solid-state electrolyte 126. Prior to reaching the operating temperature, the zirconium oxide resistance, and thus the Nernst cell resistance, is even higher, and more voltage drop occurs across the volume of solid-state electrolyte 126. However, the interface between electrodes 124, 128, i.e., for example the platinum electrodes, and the solid-state electrolyte 126 does not experience any significantly higher voltage drop during this heating phase. However, damage due to excessively high voltage ordinarily occurs at these interfaces, since zirconium oxide is reduced and metallic zirconium is produced in these locations, which causes sensor element 112 or ceramic layer structure 122 to turn brown and an electrical shunt to occur. Due to the overwhelmingly large voltage drop in the inner volume of solid-state electrolyte 126, however, this will not occur in the present case.

External voltage preferably is not present at the heating meander of heating element 136 and Nernst cell 138 between two consecutive heating phases. The Nernst voltage, and thus the exhaust gas composition, may be ascertained during this period. If a rich exhaust gas is present in measuring gas chamber 130, Nernst cell 138 generates a voltage of approximately 800 mV. This voltage results in a current flow across protective resistor 150 and the heating meander, which is I=0.8 V/(30 Ohm+20 Ohm+120 Ohm)=4.7 mA. A current having this absolute value may be supplied from Nernst cell 138 without problems.

To prevent reference air channel 134 from being “pumped dry,” or to prevent a measurable change in the composition of the atmosphere in this reference air channel 134, this reference air channel 134 should be provided with a high storage volume and/or a high limiting current. As an alternative or in addition, heating element 136 may be operated in a further specific embodiment in such a way that alternating polarity is applied to heating element 136, using a suitable design of electrical energy source 158 and/or using an additional polarity reversal switch in controller 114. This also makes it possible to avoid emptying reference air channel 134. In applying alternating polarities in this manner, the positive polarity is preferably applied to heating element 136 for a longer period of time to slightly “pump up” reference gas chamber 132, i.e., to apply a higher oxygen partial pressure thereto. In the specific embodiment illustrated in FIG. 1, first heating contact 144 is preferably connected to the positive pole of electrical energy source 158, so that reference air channel 134 is filled, since the flowing current of I=(1.5 V)/20 Ohm=80 mA could otherwise provoke a shift in the electrode potential of second electrode 128 acting as the reference electrode (continuous shift down, CSD).

In the case of the current flow of 4.7 mA described above, the voltage drop across the heating meander of heating element 136 is U=4.7 mA·30 ohms=141 mV. This voltage drop is detectable by measuring device 160 between first heating contact 144 and ground 120. If a lean exhaust gas composition is present, a voltage of approximately U=0 mV is measured here.

Any interference voltages which may be present at vehicle ground 120 typically are up to approximately 50 mV. This value must be protected on an application-specific basis. If this value of the interference voltages occurs in the range of the voltages to be measured by measuring device 160, the resistance values described above, in particular the value of protective resistor 150, must be dimensioned differently.

In the alternative method without protective resistor 150 described above, the inner resistance of Nernst cell 138 is, for example, 140Ω. This results in at least approximately the same voltages as in the above-described exemplary embodiment having protective resistor 150.

In the exemplary embodiment illustrated in FIG. 1, sensor element 112 is designed as a sensor element having reference air channel 134. However, a pumped reference may be used as an alternative or in addition, as described above. In the case of a pumped reference of this type, the polarity of Nernst cell 138 may be designed in such a way that reference gas chamber 132 is pumped up, using oxygen, during the heating phases in which, for example, 1.5 V may be present at Nernst cell 138. This means that first electrode 124, or an additional pump electrode which is used for filling reference gas chamber 132, should be operated as an anode, i.e., it should be connected to a negative pole of a pump voltage source.

1-13. (canceled)

14. A sensor element for determining at least one physical property of a gas in a measuring gas chamber, comprising:
a first electrode and a second electrode;
at least one solid-state electrolyte connecting the first and second electrodes; and
at least one heating element having a first heating contact and a second heating contact;
wherein the first heating contact and the first electrode are contacted via a common connecting line, and the second heating contact and the second electrode are connected to a common ground line.

15. The sensor element as recited in claim 14, wherein the first electrode is connected to the measuring gas chamber, and the second electrode is connected to a reference gas chamber which is isolated from the measuring gas chamber.

16. The sensor element as recited in claim 15, wherein the reference gas chamber is at least one of: (i) part of a reference gas channel connected to a working environment, and (ii) a closed reference gas chamber.

17. The sensor element as recited in claim 15, further comprising:
at least one further pump electrode configured to operate the reference gas chamber as a pumped reference gas chamber;
wherein the reference gas chamber is a closed reference gas chamber.

18. The sensor element as recited in claim 15, further comprising:
at least one protective resistor provided between the first electrode and the common connecting line.

19. The sensor element as recited in claim 18, wherein the first electrode, the solid-state electrolyte, and the second electrode form a Nernst cell having a Nernst cell resistance, and wherein the protective resistor is selected to have an absolute value 2 to 10 times the absolute value of the Nernst cell resistance during operation of the sensor element.

20. The sensor element as recited in claim 18, wherein the first electrode, the solid-state electrolyte, and the second electrode form a Nernst cell having a Nernst cell resistance, a resistance of the heating element being at least approximately one fifth of the Nernst cell resistance at an operating temperature.

21. A sensor system for determining at least one physical property of a gas in a measuring gas chamber, comprising:
at least one sensor element for determining at least one physical property of a gas in a measuring gas chamber, the sensor element including:
a first electrode and a second electrode;
at least one solid-state electrolyte connecting the first and second electrodes; and
at least one heating element having a first heating contact and a second heating contact;
wherein the first heating contact and the first electrode are contacted via a common connecting line, and the second heating contact and the second electrode are connected to a common ground line, and wherein the first electrode is connected to the measuring gas chamber, and the second electrode is connected to a reference gas chamber which is isolated from the measuring gas chamber; and
at least one controller configured to connect the common connecting line to one of an electrical energy source, a voltage measuring device, or a current measuring device.

22. The sensor system as recited in claim 21, wherein the controller is configured to operate the sensor element in such a way that a ground line is connected to an electrical ground.

23. The sensor system as recited in claim 21, wherein the controller is configured to connect a connecting line to the electrical energy source during at least one heating phase, and wherein the controller is further configured to connect the connecting line to one of the voltage measuring device or the current measuring device during at least one measuring phase, the controller being further configured to infer at least one of an oxygen concentration and an oxygen partial pressure from at least one signal of the measuring device.

24. The sensor system as recited in claim 23, wherein the controller is configured to carry out a cyclical measurement with heating phases and measuring phases being carried out alternately.

25. The sensor system as recited in claim 24, wherein the heating phases are longer than the measuring phases.

26. The sensor system as recited in claim 24, wherein the controller is configured to operate the heating element with alternating electrical polarity in consecutive heating phases.
